(19) United States
(12) Patent Application Publication
(10) Pub. No.: US 2008/0117212 A1
(43) Pub. Date: May 22, 2008

(54) Method, medium and system rendering 3-dimensional graphics using a multi-pipeline

(75) Inventors: Sang-oak Woo, Anyang-si (KR); Seok-yoon Jung, Seoul (KR); Chan-min Park, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/826,167

(22) Filed: Jul. 12, 2007

(30) Foreign Application Priority Data
Nov. 20, 2006 (KR) 10-2006-0114718

(51) Int. Cl. G06T 15/10

(52) U.S. Cl. 345/427

(57) ABSTRACT

A method and system for rendering graphic data using a multi-pipeline are provided. The rendering system includes, a rendering unit to transmit each of a plurality of objects included in graphic data to one of multiple pipelines based on a rendering position at which each object is to be rendered on a screen, and to render the object, a composition unit to combine rendering results corresponding to an overlap region in which the rendering results of pipelines overlap each other on the screen, and an image generator to generate a final rendering image of the graphic data by combining the combined rendering results with rendering results which correspond to residual regions excluding the overlap region on the screen.

### CROSS-REFERENCE TO RELATED APPLICATIONS

This application claims the benefit of Korean Patent Application No. 10-2006-0114718, filed on Nov. 20, 2006, in the Korean Intellectual Property Office, the disclosure of which is incorporated herein in its entirety by reference.

### BACKGROUND

1. Field

One or more embodiments of the present invention relate to a method, medium and system rendering 3-dimensional (3D) graphic data, and more particularly, to a method, medium and system improving rendering performance of a multi-pipeline in which 3D graphic data is rendered in parallel.

2. Description of the Related Art

Rendering 3-dimensional (3D) graphic data usually includes a geometry stage and a rasterization stage. In the geometry stage, a 3D object in the 3D graphic data is converted into 2-dimensional (2D) information for 2D display. Here, coordinates of a 3D object composed of primitive elements such as a vertex, a line, and a triangle are detected on a display screen. In the rasterization stage, a pixel image is produced for the object defined by the 2D coordinates. Visibility is determined considering the depth of each pixel, and the color of each pixel is determined with reference to the determined visibility. Such 3D graphic data rendering requires large amounts of computation. In particular, large amounts of computation are required in the rasterization stage, in which values must be calculated for each pixel.

In order to improve rendering performance, parallel processing techniques for graphic data have been proposed. A screen subdivision method and an image composition method are representative parallel processing techniques. FIG. 1A illustrates a parallel processing method using screen subdivision. FIG. 1B illustrates a parallel processing method using image composition.

Referring to FIG. 1A, a particular rendering region on a screen image to be rendered is allocated to each pipeline so that each pipeline renders only the particular rendering region allocated thereto. After renderings at all pipelines are complete, rendering results of the respective pipelines are combined, thereby producing a final rendering image. In this technique, all objects included in the particular rendering region allocated to each pipeline should be input. Accordingly, a rendering region, in which current objects are included needs to be identified and the current objects need to be transmitted to a pipeline to which the identified rendering region is allocated. This work is referred to as “sorting”. Sorting takes a large amount of time. Moreover, according to the screen division technique, when an object is included in both of an A rendering region and a B rendering region, both of an A pipeline allocated to the A rendering region and a B pipeline allocated to the B rendering region render the object. As a result, one object is redundantly rendered, which causes the rendering performance to be degraded.

Referring to FIG. 1B, in the image composition technique, input graphic data is arbitrarily divided and then rendered by pipelines. Each pipeline can render any data. Accordingly, sorting is not required and data is not redundantly rendered by different pipelines. However, in order to combine rendering results of the pipelines, the rendering results need to be compared between the pipelines in pixel units. Accordingly, it takes a large amount of time to compose an image by combining the rendering results. When graphic data is rendered by four pipelines, as illustrated in FIG. 1B, a procedure for combining rendering results of first and second pipelines, a procedure for combining rendering result of third and fourth pipelines, and a procedure for combining the results of the two combining procedures are required, i.e., three combining procedures are required. Since each combining procedure is processed in pixel units, a huge amount of memory access is required. As a result, power consumption is increased and rendering speed decreased. Consequently, rendering performance is degraded.

### SUMMARY

One or more embodiments of the present invention provide a rendering method for improving rendering performance of a multi-pipeline by minimizing the number of operations required for combining results of rendering graphic data using multiple pipelines.

One or more embodiments of the present invention also provide a rendering system for improving rendering performance of a multi-pipeline by minimizing the number of operations required for combining results of rendering graphic data using multiple pipelines.

One or more embodiments of the present invention also provide a computer readable recording medium for recording a program for executing the rendering method on a computer.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a rendering method including, transmitting each of a plurality of objects included in graphic data to one of multiple pipelines based on a rendering position at which each object is to be rendered on a screen, and rendering the object using the pipeline, combining rendering results corresponding to an overlap region in which the rendering results of pipelines overlap each other on the screen, and generating a final rendering image of the graphic data by combining the combined rendering results with rendering results which correspond to residual regions excluding the overlap region on the screen.

To achieve at least the above and/or other aspects and advantages, embodiments of the present invention include a rendering method including, performing vertex processing on a plurality of objects included in graphic data, transmitting each of the vertex processed objects to one of multiple pipelines based on a rendering position at which each object is to be rendered on a screen, and performing pixel processing on the object using the pipeline, combining pixel processing results corresponding to an overlap region in which the pixel processing results of pipelines overlap each other on the screen, and generating a final rendering image of the graphic data by combining the combined pixel processing results with pixel processing results which correspond to residual regions excluding the overlap region on the screen.

To achieve at least the above and/or other aspects and advantages, embodiments of the present invention include a rendering system including, a rendering unit to transmit each of a plurality of objects included in graphic data to one of multiple pipelines based on a rendering position at which each object is to be rendered on a screen, and to render the object, a composition unit to combine rendering results corresponding to an overlap region, in which the rendering results of pipelines overlap each other on the screen, and an image generator to generate a final rendering image of the graphic data by combining the combined rendering results with rendering results which correspond to residual regions excluding the overlap region on the screen.

To achieve at least the above and/or other aspects and advantages, embodiments of the present invention include a rendering system including, a vertex processor to perform vertex processing on objects included in graphic data, a pixel processor to transmit each of the vertex processed objects to one of multiple pipelines based on a rendering position at which each object is to be rendered on a screen, and performing pixel processing on the object using the pipeline, a composition unit to combine pixel processing results corresponding to an overlap region in which the pixel processing results of pipelines overlap each other on the screen, and an image generator to generate a final rendering image of the graphic data by combining the combined pixel processing results with pixel processing results which correspond to residual regions excluding the overlap region on the screen.

To achieve at least the above and/or other aspects and advantages, embodiments of the present invention include a computer readable recording medium for recording a program for executing the method on a computer.

### BRIEF DESCRIPTION OF THE DRAWINGS

These and/or other aspects and advantages of the invention will become apparent and more readily appreciated from the following description of embodiments, taken in conjunction with the accompanying drawings of which:

FIGS. 1A and 1B illustrate conventional parallel processing techniques for graphic data;

FIG. 2 illustrates a rendering system, according to an embodiment of the present invention;

FIGS. 3A through 3F illustrate operations of the rendering system, according to an embodiment of the present invention;

FIG. 4 is illustrates a rendering system, according to an embodiment of the present invention;

FIG. 5 illustrates a rendering method, according to an embodiment of the present invention; and

FIG. 6 illustrates a rendering method, according to an embodiment of the present invention.

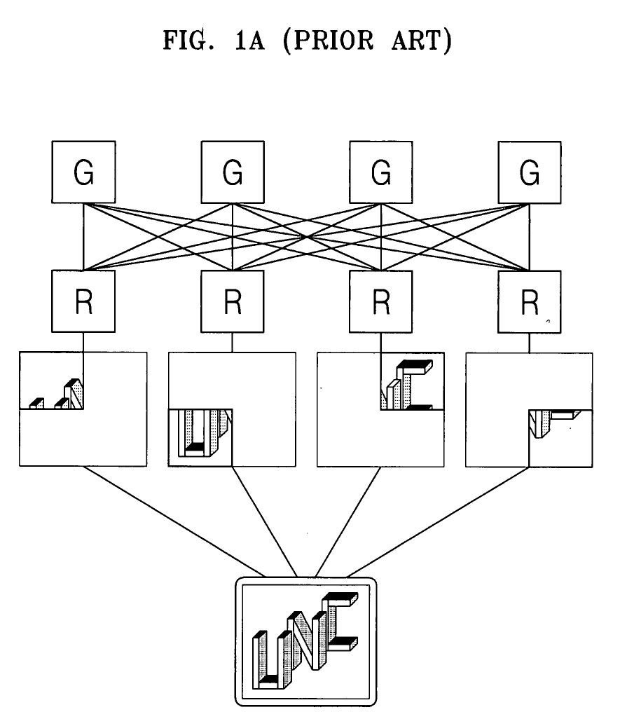

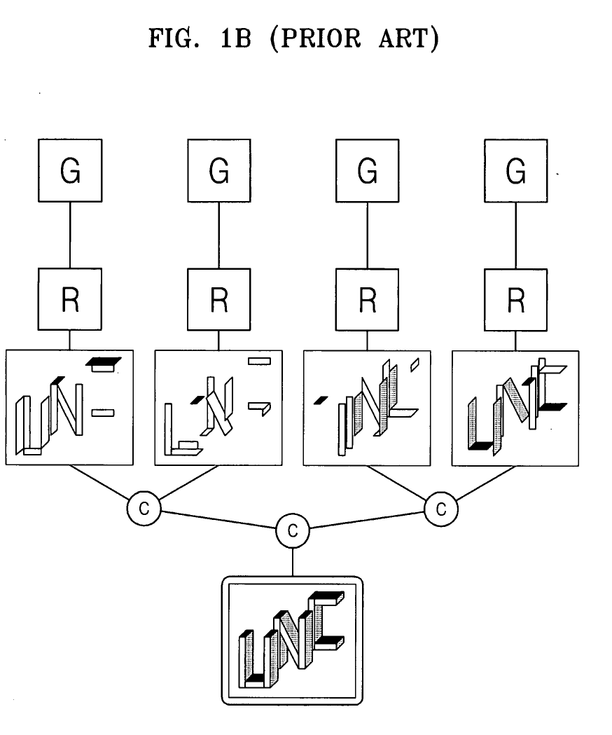

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

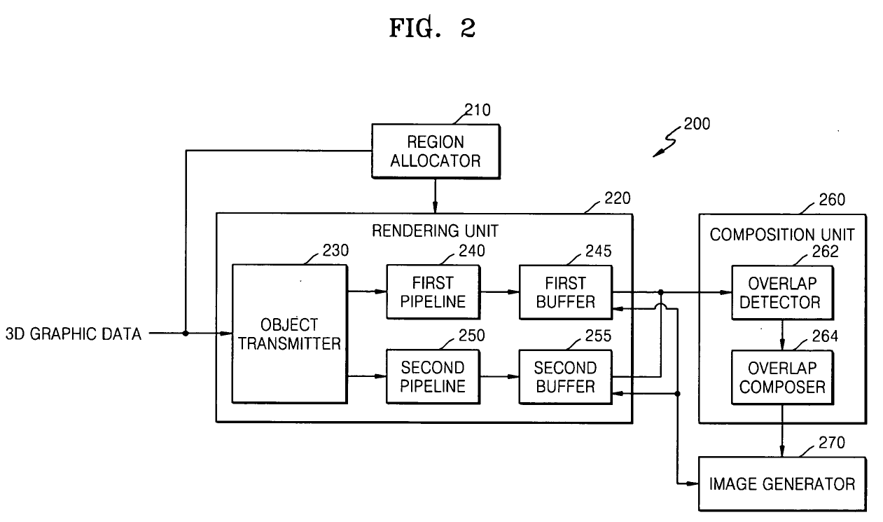

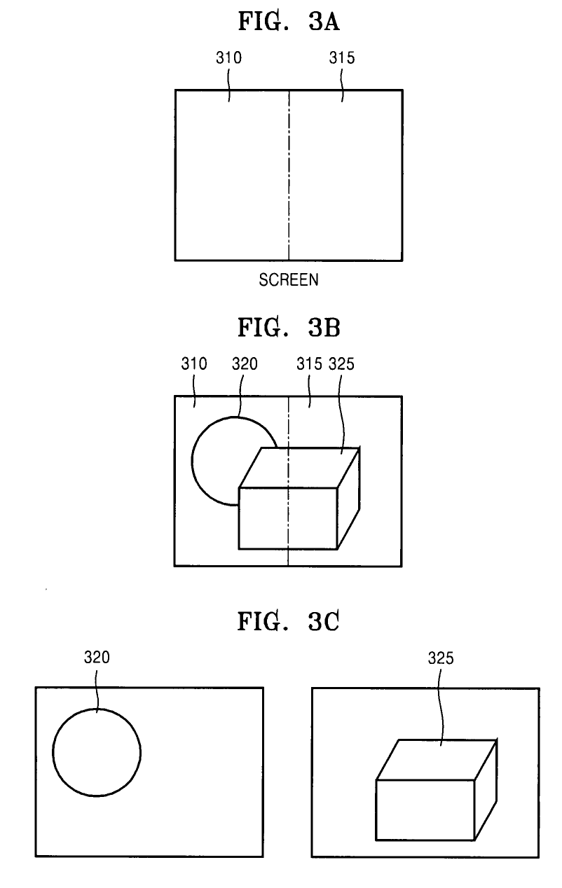

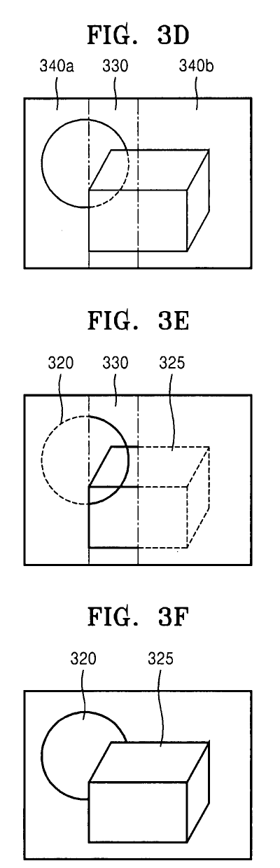

FIG. 2 illustrates a rendering system 200, according to an embodiment of the present invention. FIGS. 3A through 3F illustrate operations of the rendering system 200, according to an embodiment of the present invention. Hereinafter, the structure and the operations of the rendering system 200 will be described with reference to FIGS. 2 through 3F. In an embodiment of the present invention, a multi-pipeline includes two pipelines. However, it will be understood by those of ordinary skill in the art that two or more rendering pipelines may be used in other embodiments of the present invention.

The rendering system 200 may include, for example, a region allocator 210, a rendering unit 220, a composition unit 260, and an image generator 280. The rendering unit 220 may include, for example, an object transmitter 230, a first pipeline 240, a second pipeline 250, and first and second buffers 245 and 255, which respectively correspond to the first and second pipelines 240 and 250. The composition unit 260 may include, for example, an overlap detector 262 and an overlap composer 264.

The region allocator 210 may divide a screen image area into a plurality of rendering regions and may allocate the rendering regions to a plurality of pipelines, respectively. FIG. 3A illustrates, as an example, a first rendering region 310 and a second rendering region 315, which are generated and allocated to the first and second pipelines 240 and 250, respectively, by the region allocator 210. Referring to FIG. 3A, the region allocator 210 may divide a screen image area using a vertical line and allocate a left region, e.g., the first rendering region 310 to the first pipeline 240 and a right region, e.g., the second rendering region 315 to the second pipeline 250. Every time graphic data is input, the region allocator 210 may divide a screen image area into the first and second rendering regions 310 and 315 in various forms. Alternatively, the first and second rendering regions 310 and 315 may be fixed so that a predetermined fixed region is allocated to each of the pipelines 240 and 250. Here, a rendering region may be directly preset in each of the first and second pipelines 240 and 250 and the region allocator 210 may not need to allocate the rendering regions to the first and second pipelines 240 and 250.

However, in an embodiment it may be desirable that the region allocator 210 analyze the characteristics of input graphic data and divide a screen image area into rendering regions considering the analyzed characteristics. For instance, the region allocator 210 may estimate distribution of objects on an input graphic image and, if objects are mainly gathered on the left side of the image, divide the screen image into rendering regions considering the estimated distribution so that the numbers of objects included in the individual rendering regions may be similar, e.g., dividing a screen image into a top half and a bottom half rather than a left and right half, and therefore, individual pipelines may process similar amounts of operation.

In addition, the region allocator 210 may need to prevent the divided rendering regions from overlapping each other. If the rendering regions overlap each other, an overlap region may be processed by a plurality of pipelines, and consequently, an object in the overlap region may be redundantly rendered by the plurality of pipelines. In an embodiment, the region allocator 210 should perform division so as to prevent this redundant rendering.

The rendering unit 220 may render objects in the input graphic data using the first and second pipelines 240 and 250, according to rendering positions at which the individual objects are to be rendered on a screen. In the rendering unit 220, the object transmitter 230 may select one of the first and second pipelines 240 and 250 for each object included in the input graphic data based on the rendering position of the object on the screen and transmit the object to the selected pipeline 240 or 250. The object transmitter 230 may determine the rendering position of each object and select the pipeline 240 or 250, to which a rendering region including the rendering position may be allocated, for the object.

According to an embodiment of the present invention, the object transmitter 230 may determine the rendering position of an object using the central point of the object. For instance, the object transmitter 230 may calculate the central point of the object and detect a position, to which the central point of the object may be projected on a screen. Thereafter, the object transmitter 230 may search for a rendering region including the detected position on the screen in the rendering regions defined by the region allocator 210 and transmit the object to the pipeline 240 or 250, to which the searched rendering region is allocated. Referring to FIG. 3A, objects whose central points are included in the first rendering region 310 may be transmitted to the first pipeline 240 and objects whose central points are included in the second rendering region 320 may be transmitted to the second pipeline 250, for example.

In other embodiments of the present invention, the object transmitter 230 may determine the rendering position of an object using an area occupied on a screen by the bounding volume of the object. The bounding volume may indicate a box, a sphere, or the like, having a minimum volume covering an overall volume occupied by a 3-dimensional (3D) object in space. Unlike the central point of the object, represented by a single point on the screen, the bounding volume of the object may be represented by a region with an area on the screen and may thus expand over a plurality of rendering regions. Accordingly, the object transmitter 230 may calculate an area occupied by the bounding volume of the object on the screen and transmit the object to a pipeline allocated to the rendering region with the largest area occupied by the bounding volume, among rendering regions defined by the region allocator 210. This example merely represents an embodiment of the present invention, and those of ordinary skill in the art will understand that a rendering region including an object may be identified using diverse methods.

FIG. 3B illustrates a first object 320 and a second object 325 included in input graphic data. The object transmitter 230 may calculate the central point of the first object 320, select the first rendering region 310 for the first object 320 since the central point of the first object 320 on a screen is included in the first rendering region 310, and may transmit the first object 320 to the first pipeline 240. In addition, the object transmitter 230 may calculate the central point of the second object 325, select the second rendering region 315 for the second object 325 since the central point of the second object 325 on a screen is included in the second rendering region 315, and may transmit the second object 325 to the second pipeline 250.

The first pipeline 240 and the second pipeline 250 may respectively render objects transmitted from the object transmitter 230 and store rendering results in the first buffer 245 and the second buffer 255, respectively. Each of the first buffer 245 and the second buffer 255 may be implemented by memory having capacity corresponding to the area of a screen.

Typically, rendering of 3D graphic data includes vertex processing (i.e., a geometry stage) and pixel processing (i.e., a rasterization stage), which have been described. Thus, a more detailed description thereof will be omitted. The first and second pipelines 240 and 250 may perform an overall rendering procedure including vertex processing and pixel processing.

In the conventional graphic data parallel processing technique using screen subdivision, each pipeline may render a fixed rendering region, and therefore, a buffer that stores the rendering result of the pipeline may be implemented by memory having capacity corresponding to a size of a rendering region allocated to the pipeline. However, in an embodiment of the present invention, each pipeline may not render a rendering region allocated thereto but may render an object included in the rendering region. In addition, the rendering region allocated to each pipeline may be changed. Accordingly, in an embodiment, a buffer that stores the rendering result of each pipeline should be implemented by memory having capacity corresponding to the entire size of a screen.

The first and second buffers 245 and 255 may respectively store the rendering results of the first and second pipelines 240 and 250. The rendering results may include, for example, the depth values and the color values of respective rendered pixels. Accordingly, the first buffer 245 may include a first depth buffer and a first color buffer and the second buffer 255 may include a second depth buffer and a second color buffer. As described above, in an embodiment, each of the first and second buffers 245 and 255 should be implemented by memory having capacity corresponding to the size of the entire screen.

FIG. 3C illustrates a state where results of rendering the first and second objects 320 and 325 respectively using the first and second pipelines 240 and 250 may be respectively stored in the first and second buffers 245 and 255, for example.

The composition unit 260 may detect an overlap region where the rendering results overlap each other on a screen and combine the rendering results corresponding to the detected overlap region. In the composition unit 260, the overlap detector 262 may detect an overlap region where the rendering results of the respective first and second pipelines 240 and 250, e.g., the rendering results stored in the respective first and second buffers 245 and 255, overlap each other on the screen. FIG. 3D illustrates an overlap region 330 in which the rendering results of the first and second pipelines 240 and 250 may overlap each other on the screen.

The overlap composer 264 may combine rendering results corresponding to the overlap region 330 detected by the overlap detector 262, among the rendering results of the first and second pipelines 240 and 250. As described above, a rendering result may include the depth values and color values of respective pixels constructing a rendered object. Accordingly, the rendering results corresponding to the overlap region 330 may be the depth value and the color value of each pixel included in the overlap region 330.

The rendering results in the overlap region 330 may be combined in order to display objects that overlap each other on a screen as they are actually viewed while overlapping each other. According to an embodiment of the present invention, the overlap composer 264 may select a depth value closer to the screen than any other depth values with respect to each pixel included in the overlap region 330 and set as a color value of the pixel a color value corresponding to the selected depth value among the color values obtained as the rendering results for the pixel. This procedure is performed to set, as the depth value and the color value of each pixel, the depth value and the color value of an object closest to the screen among objects overlapping each other in the overlap region 330. FIG. 3E illustrates a composition result of the composition unit 260 which may combine the rendering results corresponding to the overlap region 330. Since the second object 325 may be closer to the screen than the first object 320, the depth value and the color value of the second object 325 may be determined as the depth and color values of each pixel included in the overlap region 330.

The image generator 280 may generate a final rendering image for the input graphic data from the composition result of the composition unit 260 combining the rendering results corresponding to the overlap region 330 and the rendering results of the first and second pipelines 240 and 250 corresponding to residual regions 340a and 340b, except for the overlap region 330. The image generator 280 may store all of the rendering results of the first and second pipelines 240 and 250, except for the rendering results which correspond to the overlap region 330, in a correspondent area of a predetermined buffer and store the composition result of the composition unit 260 for the overlap region 330 in the other correspondent area of the predetermined buffer so as to generate the final rendering image of the input graphic data. FIG. 3F illustrates a state in which the final rendering image for the first and second objects 320 and 325 may be stored in a predetermined buffer.

Either of the first and second buffers 254 and 256 may be used as a predetermined buffer. Here, a procedure for storing the rendering results corresponding to the residual regions 340a and 340b in the buffer 254 or 256 used as the predetermined buffer may be omitted since the buffer 254 or 256 may have already stored the rendering result corresponding to the residual region 340a or 340b. Accordingly, when one of the first and second buffers 245 and 255 that store the rendering result corresponding to the larger of the residual regions 340a and 340b is used as the predetermined buffer, power consumption for transmitting the rendering results to other buffers may be minimized. For instance, when the residual region 340b corresponding to the second buffer 255 is larger than the residual region 340a corresponding to the first buffer 245, copying the rendering result stored in the first buffer 245 to the second buffer 255 may require fewer calculations than vice-versa. At this time, when the rendering result corresponding to the residual region 340a stored in the first buffer 245 and the composition result corresponding to the overlap region 330 are stored in the second buffer 255, the number of memory accesses needed to generate the final rendering image may be minimized, and therefore, rendering efficiency may be increased.

According to an embodiment of the present invention, the rendering system 200 may transmit the final rendering image, generated by the image generator 280, with respect to the input graphic data, to an output unit (not shown) so that the image may be displayed on the screen.

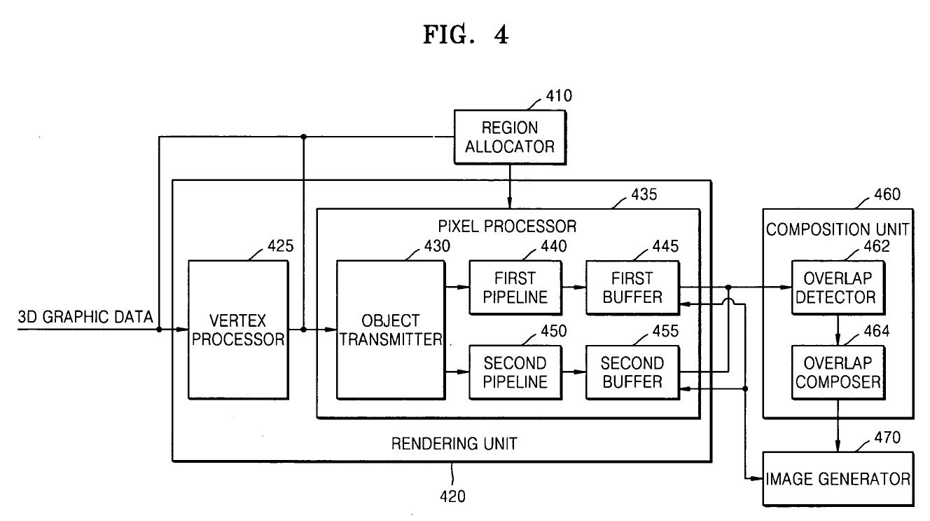

Hereinafter, the structure and the operations of a rendering system 400 according to an embodiment of the present invention will be described with reference to FIG. 4. Descriptions that are similar or identical to those discussed previously above will be simply mentioned for sake of brevity. The rendering system 400 may include, for example, a region allocator 410, a rendering unit 420, a composition unit 460, and an image generator 480. The rendering unit 420 may include, for example, a vertex processor 425 and a pixel processor 435. The pixel processor 435 may include, for example, an object transmitter 430, a first pipeline 440, a second pipeline 450, and first and second buffers 445 and 455 respectively corresponding to the first and second pipelines 440 and 450. The composition unit 460 may include, for example, an overlap detector 462 and an overlap composer 464.

The region allocator 410 may divide a screen image area into a plurality of rendering regions and allocate the rendering regions to the first and second pipelines 440 and 450, respectively, for example. The region allocator 410 may analyze the characteristics of input graphic data and divide the screen image area into rendering regions based on the analyzed characteristics. Alternatively, the region allocator 410 may divide the screen image area into rendering regions based on a vertex processing result of the vertex processor 425.

The vertex processor 425 may perform vertex processing in order to obtain vertices of each object included in the input graphic data. The vertex processing may describe a procedure of converting a 3D object into 2-dimensional (2D) information in order to express the 3D object on a 2D screen. The vertex-processed 3D object may be represented by coordinates of the vertices of the 3D object and the depth values and the color values of the vertices.

The object transmitter 430 may determine a rendering position for each object that has been subjected to vertex processing and transmit the object to the first or second pipeline 440 or 450, to which a rendering region including the determined rendering position may be allocated. According to an embodiment of the present invention, the object transmitter 430 may easily obtain a vertex processing result for each object from the vertex processor 425, and therefore, it may easily calculate a rendering position at which the object will be rendered on a screen, and may easily identify a rendering region including the calculated rendering position.

The first and second pipelines 440 and 450 may perform pixel processing with respect to vertex-processed objects that are respectively transmitted from the object transmitter 430 to the first and second pipelines 440 and 450, and may store pixel processing results in the first and second buffers 445 and 455, respectively. Pixel processing may refer to a procedure of generating a pixel image from an object which has been vertex processed and represented by 2D coordinates. During pixel processing, the depth value and the color value of each of pixels making up the object may be calculated. As described above, each of the first and second buffers 445 and 455 may include a depth buffer and a color buffer. The depth value of each pixel may be stored in the depth buffer and the color value of the pixel may be stored in the color buffer.

The structures and the operations of the composition unit 460 and the image generator 480 may be similar to those of the composition unit 260 and the image generator 280, and thus, further descriptions thereof will be omitted.

As described above, according to an embodiment of the present invention, vertex processing and pixel processing may be performed in a single pipeline. Here, an object in graphic data may be transmitted to a pipeline and the pipeline may perform vertex processing and pixel processing on the object. Alternatively, according to an embodiment of the present invention, vertex processing may be performed on each object in graphic data and a pipeline may be selected for the vertex processed object. Thereafter, the selected pipeline may perform pixel processing on only the vertex processed object. Since the amount of computation required for pixel processing is typically more than that required for vertex processing, it may be desirable to perform pixel processing by multiple pipelines in parallel without requiring the pipelines to perform vertex processing.

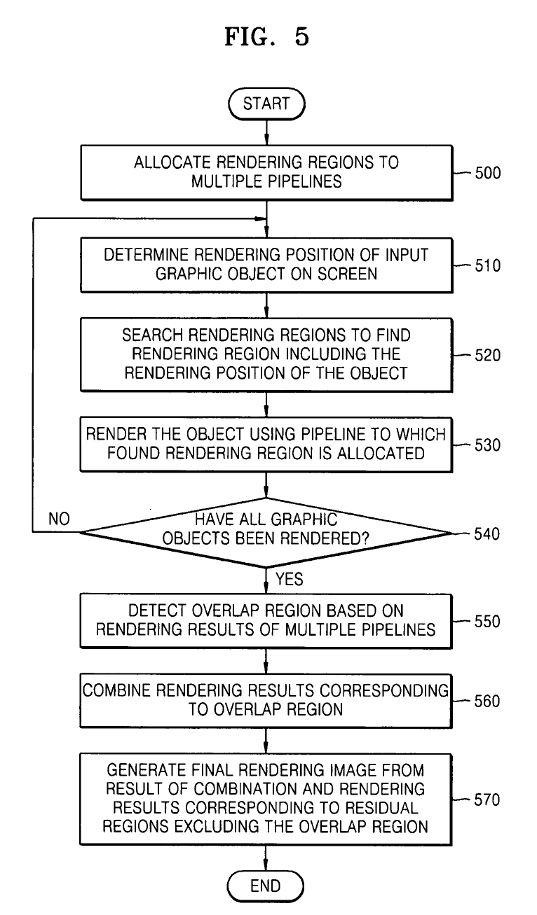

A rendering method, according to an embodiment of the present invention will be described with reference to FIG. 5 below.

In operation 500, a screen image may be divided, e.g., by a rendering system, into a plurality of rendering regions based on the characteristics of input graphic objects and the rendering regions may be allocated to multiple pipelines. In an embodiment, the rendering regions allocated to the respective multiple pipelines may not overlap each other and may be changed according to characteristics of input graphic data. The characteristics of the input graphic data may be considered when dividing the screen image into a plurality of rendering regions. For instance, the distribution of the graphic objects on the screen image may be estimated and, if objects are mainly gathered on the left side of the image, the screen image may be divided into rendering regions based on the estimated distribution, e.g., dividing the screen image into a top half and a bottom half rather than a left half and right half.

In operation 510, a rendering position at which an object in the input graphic data is rendered on a screen may be determined. According to an embodiment of the present invention, the rendering position of the object on the screen may be determined based on a position of the central point of the object on the screen. In an alternative embodiment of the present invention, the rendering position of the object on the screen may be determined based on the position occupied by the bounding volume of the object on the screen. The rendering position of the object on the screen may be calculated using other methods as will be understood by those of ordinary skill in the art, and consequently these methods are construed as being included in the present invention.

In operation 520, the plurality of rendering regions may be searched to find a rendering region that may include the determined rendering position.

In operation 530, the object may be rendered using a pipeline, to which the found rendering region may be allocated.

In operation 540, it may be determined whether all objects included in the graphic data have been rendered. If it is determined that all objects have not been rendered, operations 510 through 530 may be repeated.

In operation 550, an overlap region in which rendering results of the multiple pipelines that overlap each other may be detected. The overlap region may include a portion in which images corresponding to respective rendering results of multiple pipelines overlap each other on the screen.

In operation 560, the rendering results corresponding to the detected overlap region may be combined. Here, depth values of each pixel included in the overlap region, which are included in the rendering results of the multiple pipelines may be analyzed and a depth value closest to the screen may be selected as a depth value of the pixel. Further, a color value corresponding to the selected depth value may be selected as a color value of the pixel from among color values of all of the pixels included in the rendering results of the multiple pipelines.

In operation 570, a final rendering image may be generated from the rendering results corresponding to residual regions, excluding the overlap region on the screen and a result of the rendering result combination. In the residual regions, the rendering results of the respective pipelines may not overlap each other. Accordingly, in each residual region, the rendering result of a corresponding pipeline may be directly a rendering image, and therefore, rendering a result combination performed with respect to the overlap region may not be necessary.

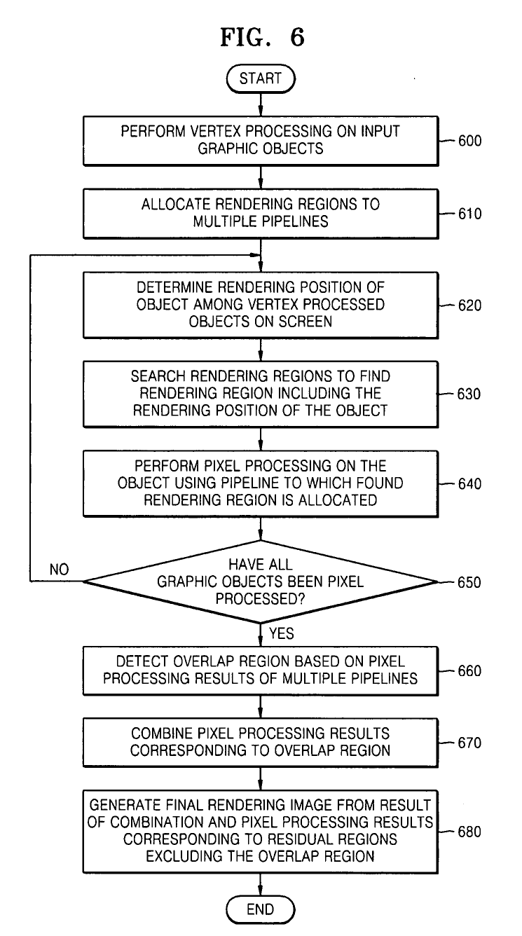

A rendering method, according to an embodiment of the present invention will be described with reference to FIG. 6 below.

In operation 600, vertex processing may be performed, e.g., by a rendering system, in order to obtain vertices of each input graphic object. Vertex processing is generally understood as a procedure for converting a 3D object into 2D information in order to express the 3D object on a 2D screen. The vertex processed 3D object may be represented by coordinates of the vertices of the 3D object and the depth values and the color values of the vertices.

In operation 610, a screen image may be divided into a plurality of rendering regions and the rendering regions allocated to multiple pipelines. In an embodiment, the rendering regions allocated to the respective multiple pipelines may not overlap each other and may be changed according to characteristics of input graphic data. Alternatively, the rendering regions may be defined based on characteristics of the input graphic data or based on a result of performing vertex processing on the graphic objects, for example.

In operation 620, a rendering position at which each vertex processed object is rendered on the screen may be determined.

In operation 630, the plurality of rendering regions may be searched to find a rendering region that includes the determined rendering position.

In operation 640, pixel processing may be performed on the object using the pipeline allocated to the found rendering region. Pixel processing is typically a procedure of generating a pixel image from an object that has been vertex processed and represented by 2D coordinates. During the pixel processing, the depth value and the color value of each of the pixels constructing the object may be calculated.

In operation 650, it may be determined whether all vertex processed objects have been pixel processed. If it is determined that all vertex processed objects have not been pixel processed, operations 620 through 640 may be repeated.

In operation 660, an overlap region may be detected based on pixel processing results of the multiple pipelines.

In operation 670, the pixel processing results corresponding to the detected overlap region may be combined. Here, depth values of each pixel included in the overlap region, which are included in the pixel processing results of the multiple pipelines may be analyzed and a depth value closest to the screen may be selected as a depth value of the pixel. Further, a color value corresponding to the selected depth value may be selected as a color value of the pixel from among color values of all of the pixels included in the rendering results of the multiple pipelines.

In operation 680, a final rendering image may be generated from the pixel processing results corresponding to residual regions excluding the overlap region on the screen and a result of the pixel processing result combination. In the residual regions, the pixel processing results of the respective pipelines may not overlap each other. Accordingly, a pixel processing result corresponding to each residual region may exist in only a single pipeline among the multiple pipelines, and therefore, pixel processing result combination performed with respect to the overlap region may not be necessary.

In a conventional parallel processing technique using image composition, objects included in graphic data are just rendered in parallel by multiple pipelines so that a rendering result of each pipeline is dispersed throughout a screen. Accordingly, in order to obtain a final rendering image of the graphic data, the rendering results of all pipelines need to be combined. For this combination, the rendering results of all pipelines need to be compared to each other in pixel units. This comparing operation requires a huge amount of memory reading and/or writing, thereby degrading rendering performance.

However, according to one or more embodiments of the present invention, the rendering positions of individual objects included in graphic data may be considered and objects having adjacent rendering positions may be rendered by one pipeline so that a rendering result of the pipeline may be collectively displayed in one region. Accordingly, an overlap region, where the rendering results of different pipelines overlap each other, may be minimized. In addition, instead of combining the rendering results corresponding to an overall screen, only rendering results corresponding to the minimized overlap region are typically combined. Accordingly, the amount of computation and operation required to generate a final rendering image of the graphic data may be reduced, and therefore, rendering performance of the multiple pipelines, which render the graphic data in parallel, can be improved.

In addition to the above described embodiments, embodiments of the present invention may also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A rendering method comprising:
transmitting each of a plurality of objects included in graphic data to one of multiple pipelines based on a rendering position at which each object is to be rendered on a screen, and rendering the object using the pipeline;
combining rendering results corresponding to an overlap region in which the rendering results of pipelines overlap each other on the screen; and
generating a final rendering image of the graphic data by combining the combined rendering results with rendering results which correspond to residual regions excluding the overlap region on the screen.

2. The rendering method of claim 1, wherein the transmitting comprises:
selecting a pipeline to render each object from among the multiple pipelines based on the rendering position of the object; and
transmitting the object to the selected pipeline and rendering the object using the pipeline.

3. The rendering method of claim 2, further comprising allocating rendering regions defined on the screen to the multiple pipelines,
wherein the selecting of the pipeline comprises selecting a pipeline to which a rendering region including the rendering position of the object is allocated, as the pipeline to render the object.

4. The rendering method of claim 3, wherein the allocating of the rendering regions comprises variably allocating the rendering regions to the multiple pipelines according to the objects included in the graphic data.

5. The rendering method of claim 3, wherein the allocating of the rendering regions comprises allocating the rendering regions to the multiple pipelines in such a manner that the rendering regions allocated to the respective multiple pipelines do not overlap each other on the screen.

6. The rendering method of claim 3, wherein the the transmitting of the plurality of objects comprises:
searching the rendering regions to find a rendering region including a rendering position of the object; and
transmitting the object to a pipeline to which the found rendering region is allocated, and rendering the object using the pipeline.

7. The rendering method of claim 6, wherein the selecting of the pipeline comprises:
determining the rendering position of the object; and
searching the rendering regions to find the rendering region including the determined rendering position.

8. The rendering method of claim 7, wherein the determining of the rendering positions comprises determining the rendering position of the object based on a central point of the object.

9. The rendering method of claim 7, wherein the determining of the rendering positions comprises determining the rendering position of the object based on an area occupied by a bounding volume of the object on the screen.

10. The rendering method of claim 1, wherein the combining of the rendering results comprises:
detecting the overlap region based on the rendering results of the multiple pipelines; and
combining the rendering results corresponding to the overlap region.

11. The rendering method of claim 10, wherein the combining of the rendering results comprises:
selecting a value closest to the screen, from among rendering results corresponding to depth values of each pixel included in the overlap region, as a depth value of the pixel; and
selecting a color value corresponding to the selected depth value of the pixel as a color value of the pixel, from among rendering results corresponding to color values of the pixel.

12. The rendering method of claim 1, wherein the generating of the final rendering image comprises:
selecting a depth value and a color value of each of pixels constructing the screen according to the result of the combination and the rendering results that correspond to the residual regions; and
storing the color value of each pixel in a predetermined buffer.

13. The rendering method of claim 12, wherein, in the storing of the color value, the depth value is stored in the predetermined buffer.

14. The rendering method of claim 13, wherein the storing of the depth value and the color value comprises storing the depth value and the color value of each pixel in one of buffers which respectively store the rendering results of the multiple pipelines.

15. The rendering method of claim 14, wherein, in the storing of the depth value and the color value, the depth value and the color value of each pixel are stored in a buffer that stores a rendering result of a pipeline corresponding to a residual region having a largest area among the residual regions.

16. A rendering method comprising:
performing vertex processing on a plurality of objects included in graphic data;
transmitting each of the vertex processed objects to one of multiple pipelines based on a rendering position at which each object is to be rendered on a screen, and performing pixel processing on the object using the pipeline;
combining pixel processing results corresponding to an overlap region in which the pixel processing results of pipelines overlap each other on the screen; and
generating a final rendering image of the graphic data by combining the combined pixel processing results with pixel processing results which correspond to residual regions excluding the overlap region on the screen.

17. A rendering system comprising:
a rendering unit to transmit each of a plurality of objects included in graphic data to one of multiple pipelines based on a rendering position at which each object is to be rendered on a screen, and to render the object;
a composition unit to combine rendering results corresponding to an overlap region, in which the rendering results of pipelines overlap each other on the screen; and
an image generator to generate a final rendering image of the graphic data by combining the combined rendering results with rendering results which correspond to residual regions excluding the overlap region on the screen.

18. The rendering system of claim 17, wherein the rendering unit comprises:
an object transmitter to select a pipeline to render each object from among the multiple pipelines based on the rendering position of the object and transmitting the object to the selected pipeline; and
a multi-pipeline comprising the multiple pipelines each of which renders the object transmitted from the object transmitter.

19. The rendering system of claim 18, further comprising a region allocator allocating rendering regions defined on the screen to the multiple pipelines,
wherein the object transmitter transmits each object to a pipeline to which a rendering region including the rendering position of the object is allocated.

20. The rendering system of claim 19, wherein the object transmitter searches the rendering regions to find a rendering region including the rendering position of the object and transmits the object to a pipeline, to which the found rendering region is allocated.

21. The rendering system of claim 17, wherein the rendering unit further comprises one or more buffers each storing a rendering result of one of the multiple pipelines.

22. The rendering system of claim 17, wherein the composition unit comprises:
an overlap detector to detect the overlap region based on the rendering results of the multiple pipelines; and
an overlap composer to combine rendering results corresponding to the overlap region.

23. The rendering system of claim 21, wherein the image generator selects a depth value and a color value of each of pixels constructing the screen according to the result of the combination and the rendering results that correspond to the residual regions and stores the color value of each pixel in one of the buffers.

24. The rendering system of claim 23, wherein the image generator stores the depth value in the one of the buffers.

25. The rendering system of claim 24, wherein the image generator stores the selected depth and color values of each pixel in a buffer that stores a rendering result of a pipeline corresponding to a residual region having a largest area among the residual regions.

26. A rendering system comprising:
a vertex processor to perform vertex processing on objects included in graphic data;
a pixel processor to transmit each of the vertex processed objects to one of multiple pipelines based on a rendering position at which each object is to be rendered on a screen, and performing pixel processing on the object using the pipeline;
a composition unit to combine pixel processing results corresponding to an overlap region in which the pixel processing results of pipelines overlap each other on the screen; and
an image generator to generate a final rendering image of the graphic data by combining the combined pixel processing results with pixel processing results which correspond to residual regions excluding the overlap region on the screen.

27. At least one medium comprising computer readable code to control at least one processing element to implement the method of any one of claims 1 through 16.
